(19) United States
(12) Patent Application Publication
(10) Pub. No.: US 2013/0174366 A1
(43) Pub. Date: Jul. 11, 2013

(54) TOOTHBRUSH WITH REFRACTIVE FACES

(71) Applicants: Jonathan M. Stebila, Grand Rapids, MI (US); Scott P. Crossman, Rockford, MI (US)

(72) Inventors: Jonathan M. Stebila, Grand Rapids, MI (US); Scott P. Crossman, Rockford, MI (US)

(73) Assignee: RANIR, LLC, Grand Rapids, MI (US)

(21) Appl. No.: 13/343,729

(22) Filed: Jan. 5, 2012

(51) Int. Cl. A46B 9/04; B29C 65/70; B23P 17/04

(52) U.S. Cl. 15/143.1; 29/527.1; 264/241

(57) ABSTRACT

A handle of a toothbrush has at least two faces for refracting light. A graphic insert having a visual design is positioned within the handle. Light transmitted from the graphic insert may be refracted by the at least two faces to provide a unique and attractive design. As the handle is rotated, the design may change appearance. The handle may include a front handle part and a rear handle part to hold the graphic insert. A securing material may be overmolded onto the front handle part and rear handle part to secure the two parts relative to one another.

### BACKGROUND OF THE INVENTION

The present invention relates to toothbrushes, and more particularly to toothbrush handles having visual designs.

Toothbrushes have incorporated a variety of visual designs to make them more attractive for consumers. Many designs include different colors or shapes printed on an exterior surface of the toothbrush. The designs may also include different textures to provide varying grips and a varying feel for the user. From use over time, the exterior designs may wear partially or completely from the toothbrush.

Other configurations cover the design in an attempt to provide protection for the design and prevent wear. One problem identified with these designs is that water, dirt and/or debris can get into the design area and it becomes very difficult, if not impossible to remove the contaminant from the toothbrush. This creates an unsanitary appearance, which makes the toothbrush undesirable for users.

Although many toothbrush designs are available, there remains room for improvement in this technology area.

### SUMMARY OF THE INVENTION

The present invention provides a handle for a toothbrush that uses refracted light to provide a visually attractive look and a method for manufacturing a handle for a toothbrush.

In one embodiment, the handle includes a front handle part, a rear handle part and a graphic insert positioned between the front handle part and the rear handle part. The front handle part and/or the rear handle part may define at least two faces for refracting light entering and exiting the front handle part and/or the rear handle part. The faces may be oriented at different angles with respect to the graphic insert such that light may be refracted differently through the different faces. When viewed through the faces, the appearance of the insert may change as a result of the light refracting through the faces.

In another embodiment, a securing material may cover at least a portion of the front handle part and the rear handle part to secure the front handle part and rear handle part relative to one another.

In another embodiment, the front handle part and/or the rear handle part define a recess for receiving the graphic insert.

In another embodiment, a handle has at least two surfaces for refracting light and a graphic insert positioned within the handle. At least two light paths may extend into the handle through each of the respective at least two surfaces, and each light path may extend at least to one side of the graphic insert. Light travelling along the light paths may exit the at least two surfaces at different angles with respect to the face of the graphic insert and with respect to each other. The appearance of the graphic insert may be modified when viewed through the at least two light paths.

In one embodiment of the method for manufacturing a toothbrush handle, the method includes (1) molding a front handle part, (2) molding a rear handle part with at least one of the front handle part and the rear handle part having at least two faces oriented at a first angle relative to one another for refracting light, (3) positioning a graphic insert between the front handle part and the rear handle part, and (4) securing the front handle part, the rear handle part and the graphic insert. Light viewed through the at least two faces exit the at least two faces at a second angle relative to one another.

In another embodiment of the method, the front handle part, rear handle part and graphic insert may be placed into a mold and an elastomer may be overmolded onto the front handle part and the rear handle part.

The handle of the present embodiments may provide an enhanced and unique visual effect for consumers, as the handle changes appearance as it is rotated. The handle may also prevent water, dirt and debris from entering the handle.

These and other objects, advantages, and features of the invention will be more fully understood and appreciated by reference to the description of the current embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and may be practiced or may be carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of a toothbrush according to one embodiment of the present invention.

FIG. 2 is a front view of the toothbrush of FIG. 1.

FIG. 3 is a side view of the toothbrush of FIG. 1.

FIG. 4 is a sectional view of the toothbrush taken along line 4-4 in FIG. 3.

FIG. 5 is an exploded view of the toothbrush of FIG. 1.

FIG. 6 is a front view of a graphic insert according to one embodiment of the present invention.

### DETAILED DESCRIPTION OF THE CURRENT EMBODIMENT

### I. Overview

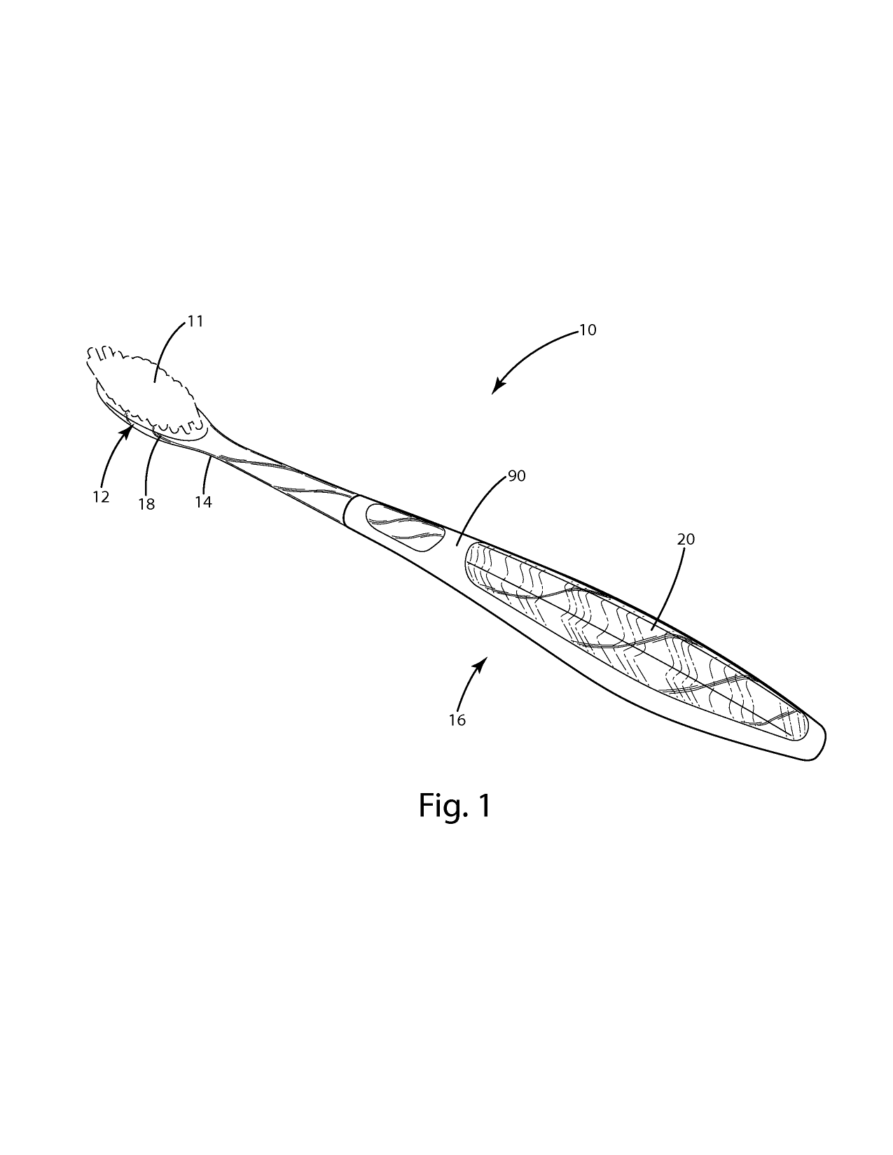

A toothbrush according to one embodiment of the present invention is shown in FIG. 1 and generally designated 10. In one embodiment, the toothbrush 10 includes a head portion 12, a neck portion 14 extending from the head portion 12, and a handle portion 16 extending from the neck portion 14. The handle portion 16 may include a graphic insert 80 positioned between a front handle part 20 and a rear handle part 40. A securing material 90 may secure the front handle part 20 and the rear handle part 40.

### II. Structure

The head portion 12 generally includes a base 18 supporting a group of cleaning elements 11. The neck portion 14 extends from the head portion 12 and generally connects the head portion 12 and the handle portion 16.

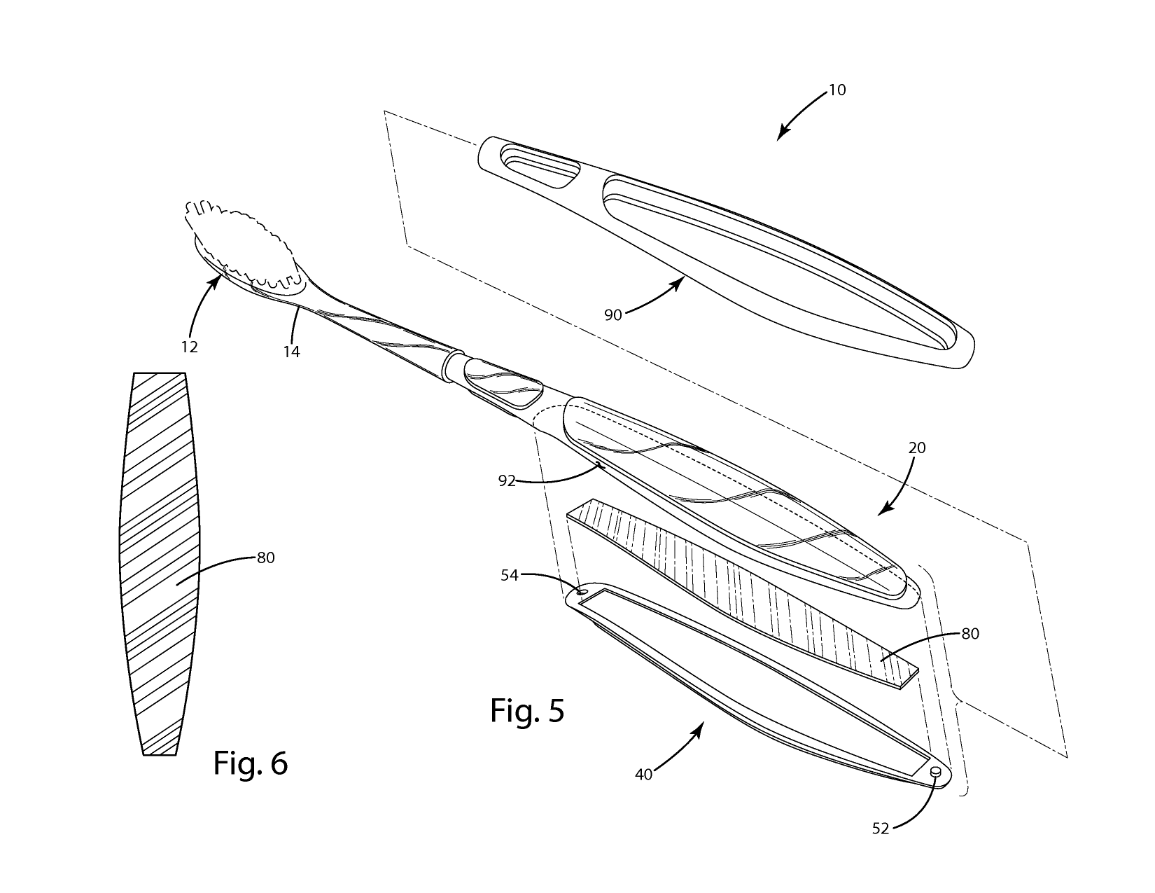

The handle portion 16 is generally an elongated structure that forms a grip to enable a user to hold the toothbrush 10. The handle portion 16 may include a front handle part 20 and a rear handle part 40 connected together to form the main body of the handle portion 16. As illustrated in FIG. 5, the front handle part 20, neck portion 14 and head portion 12 are a single piece. However, other configurations are contemplated. For example, these pieces may be separately formed and attached, or the rear handle part 40, neck portion 14 and head portion 12 may form a single piece.

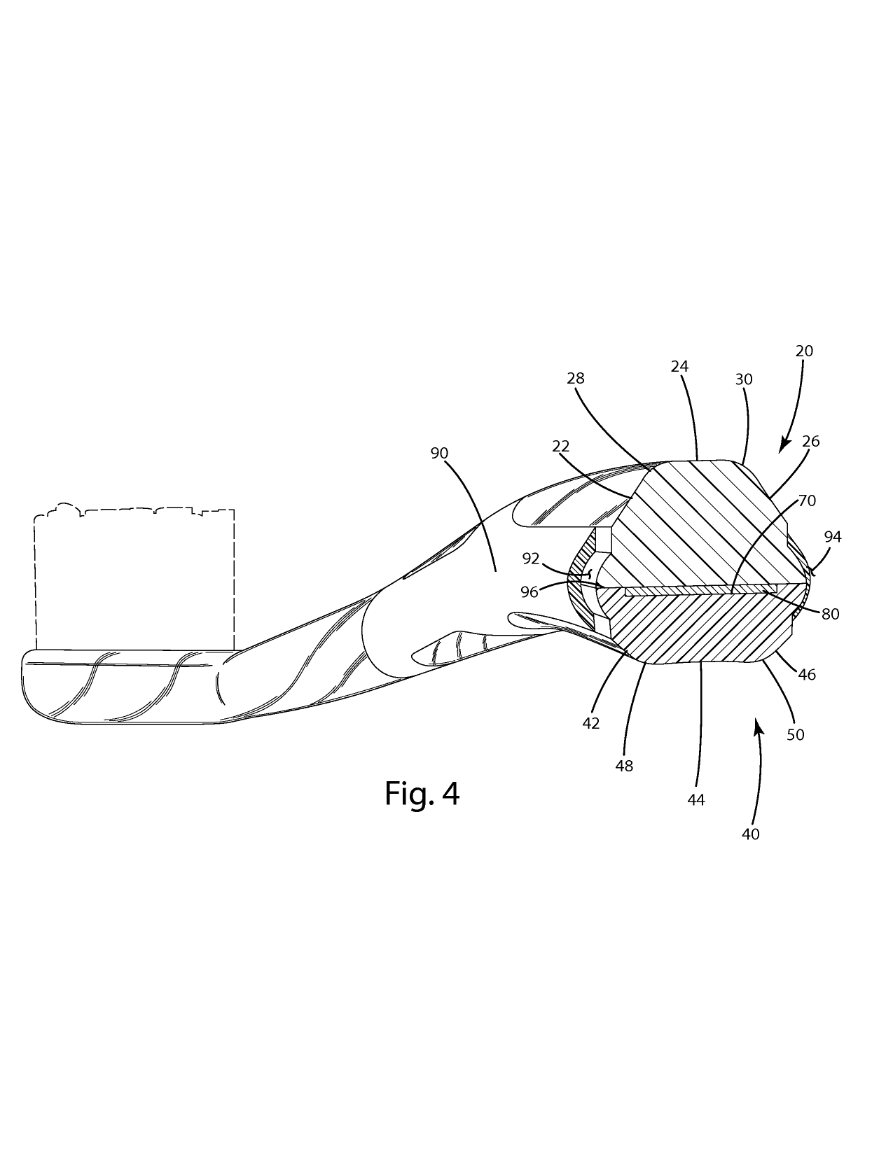

As shown in FIG. 4, the front handle part 20 may include one or more surfaces or faces 22-30 and the rear handle part 40 may include one or more surfaces or faces 42-50. The faces 22-30, 42-50 may be substantially planar, substantially curved, or any other shape suitable for the application. More or fewer faces may be included in the front handle part 20 and the rear handle part 40 than are shown in the illustrated embodiment. Two of the faces may be oriented at different angles with respect to the face of the graphic insert 80. For example, as shown in FIG. 4, the faces 22, 24, 26 are each oriented at different angles with respect to the face of the graphic insert 80. Also as shown in FIG. 4, two of the faces may define an angle between them. For example, faces 22 and 24 define an angle and faces 22 and 26 define an angle. Two of the faces may meet at a curved transition. For example, in the illustrated embodiment, faces 22 and 24 meet at face 28, which is curved and forms a transition between faces 22 and 24. Also as illustrated, faces 24 and 26 meet at face 30, which is curved and forms a transition between faces 24 and 26. Optionally, the curved faces 28 and 30 could be removed from the configuration, such that the faces 22 and 24, and the faces 24 and 26 meet at an abrupt, angled transition. The faces 42-50 of rear handle part 40 can be configured and oriented similar to faces 22-30 as described in connection with front handle part 20.

All or a portion of the front handle part 20 and/or the rear handle part 40 may be capable of transmitting light. For example, all or a portion of the front handle part 20 and/or the rear handle part 40 may be transparent, translucent, or may have any other characteristic that allows for light to be transmitted partially or completely through these elements. The front handle part 20 and the rear handle part 40 may be generally rigid and may be made of any suitable material, including a molded thermoplastic such as polypropylene. The front handle part 20 and the rear handle part 40 may be made of the same or different materials. Although not illustrated, the front handle part 20 and/or the rear handle part 40 may include any suitable alignment device. For example, a post 52 and a recess 54 may be used, as shown in FIG. 5.

As shown in FIG. 5, a graphic insert 80 may be positioned between the front handle part 20 and the rear handle part 40. The graphic insert 80 may be tightly sandwiched between front handle part 20 and rear handle part 40, may be positioned in a recess 70 defined by at least one of the front handle part 20 and rear handle part 40 (see FIG. 4), or may be otherwise positioned between the front handle part 20 and rear handle part 40 using any suitable configuration. As shown in FIG. 6, the graphic insert 80 may include a visual design. Although illustrated as a series of substantially straight lines, the design on the graphic insert 80 may be any suitable design. At least a portion of the graphic insert 80 may be capable of transmitting light. For example, in the graphic insert 80 shown in FIG. 6, the lines themselves may be substantially opaque, and the sections between the lines may be capable of transmitting light. Portions of the graphic insert 80 may be colored. For example, in FIG. 6, portions of the graphic insert between adjacent lines may form bands of one or more desired colors and other portions between adjacent lines may be void of color. The portions of the graphic insert 80 that are colored may also be capable of transmitting light. Virtually any color scheme and design is possible for the graphic insert 80.

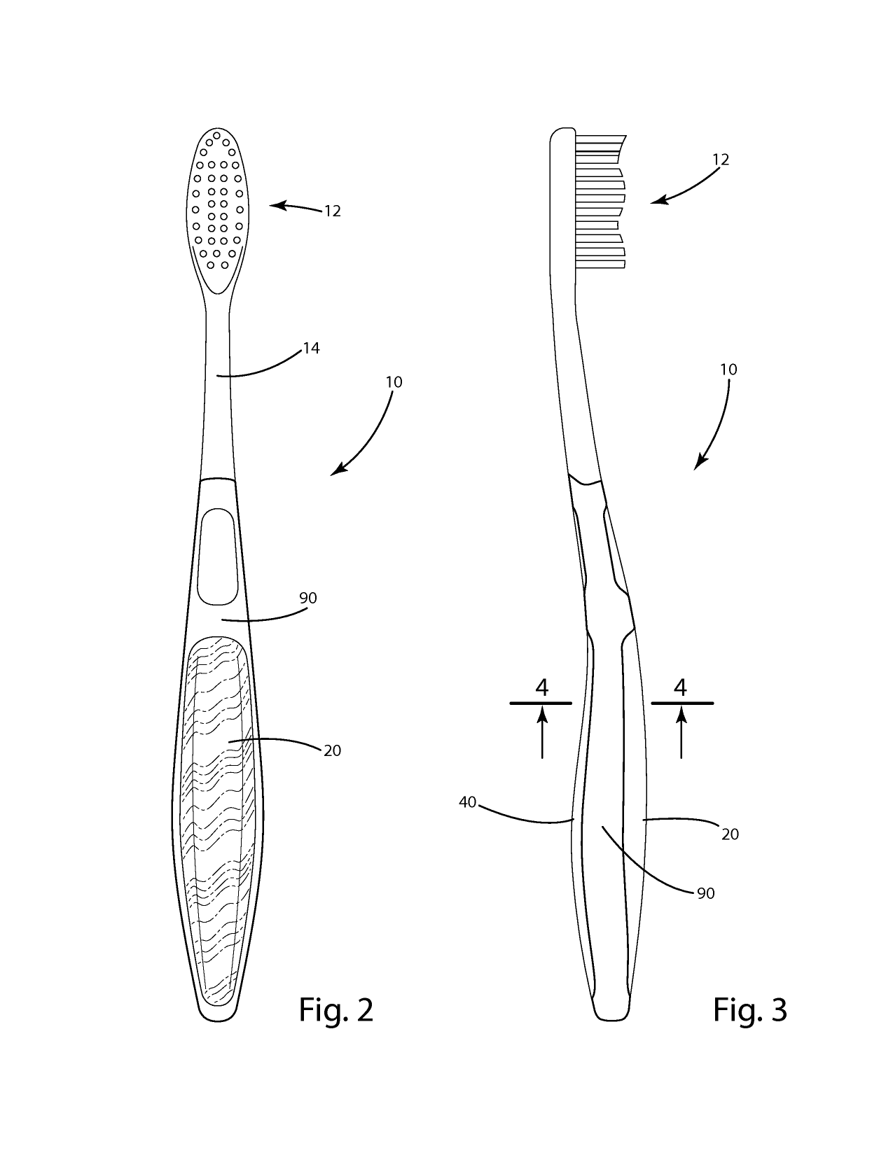

As shown in FIG. 4, the graphic insert 80 may be positioned such that at least a first and second light path may extend into the handle portion 16 through at least respective first and second faces 22-30, 42-50, through the front handle part 20 or rear handle part 40 and to the graphic insert 80. Of course, it is contemplated that light may also travel in the opposite direction (i.e. from the graphic insert 80 outward). Because the faces 22-30, 42-50 may be oriented at different angles with respect to the face of the graphic insert 80 (and with respect to one another), light travelling along the different light paths through the different faces 22-30, 42-50 may be refracted differently and may exit the different faces 22-30, 42-50 at different angles relative to one another and relative to the graphic insert 80. This relationship between the faces 22-30, 42-50 may cause the appearance of graphic insert 80 to be modified when viewed through the at least two faces 22-30, 42-50 simultaneously. For example, instead of the graphic insert 80 appearing with substantially straight lines as designed in FIG. 6, the faces 22-30, 42-50 may refract light so that the graphic insert is modified to have the appearance of FIG. 2 (i.e. non-straight lines). In the embodiment shown in FIG. 2, the substantially straight lines (FIG. 6) appear to be divided into at least three sections that appear at an angle relative to one another when viewed along the three different light paths simultaneously. In this manner, the different angles of the faces 22, 24, 26 may cause light to refract and travel along the different light paths at different angles relative to one another so that the substantially straight lines appear to be divided into three sections oriented at different angles relative to one another. In the illustrated embodiment, the three sections are divided by the transitions between the faces 22, 24, 26. In other embodiments, any waves, contours or other variations within any of the faces may create the appearance that the lines have waves, contours or other variations.

The refraction characteristics of the handle portion 16 may change as the handle portion 16 is rotated, which may change the appearance of the graphic insert 80 as the handle portion 16 is rotated. For example, the face through which a user is viewing the graphic insert 80, or the angle of the face through which a user is viewing the graphic insert 80 may be changed by rotating the handle portion 16. Any of a variety of characteristics may be changed with regard to handle portion 16. For example, the angles, curvature, number or other characteristics of the faces 22-30, 42-50 or the material included in the front handle part 20 or the rear handle part 40 may be altered to change the refraction of the light and achieve a desired visual effect.

If portions of the graphic insert transmit light (as described above), then the light path through handle portion 16 may extend into the front handle part 20 through one of the faces 22-30, through the front handle part 20, to the graphic insert 80, through the light transmitting portions of the graphic insert 80, through the rear handle part 40, through one of the faces 42-50 and out of the rear handle part 40. Of course, the light path could also extend in an opposite direction (i.e. from the rear handle part 40 through the front handle part 20). In either of these light path configurations, objects or colors positioned outside one of the sides of the handle portion 16 may be viewable from an opposite side of the handle portion 16, with the light refracted by faces of the front handle part 20 and the rear handle part 40. In another embodiment, two separate light paths may be defined, so that light travels from the front handle part 20 to one side of the graphic insert 80 and from the rear handle part 40 to the opposite side of the graphic insert 80. This situation may arise, for example, if the graphic insert 80 is completely opaque and it is desirable for the graphic insert to be viewed from the front and rear sides of the handle portion 16.

At least a portion of the front handle part 20 and/or the rear handle part 40 may be opaque and may be designed to combine with the graphic insert 80 to achieve a desired visual effect. For example, the rear handle part 40 may be one or more colors or may have one or more designs, so that when the graphic insert 80 is viewed from the front handle part 20, any light transmitting portions of the graphic insert 80 allows the one or more colors or designs to show through the graphic insert 80.

As shown in FIG. 4, the securing material 90 may be used to secure the front handle part 20 and the rear handle part 40 relative to one another. The securing material 90 may cover at least a portion of the front handle part 20 and the rear handle part 40 and may be positioned within one or more recesses 92, 94. The recesses 92, 94 may be designed to position a top surface of the securing material 90 substantially coplanar with the mating outer surfaces of the front handle part 20 and the rear handle part 40 so that a smooth transition is formed between the securing material 90, the front handle part 20 and the rear handle part 40. Portions of the securing material may extend completely around the handle portion 16 to provide additional securing for the front handle part 20 and the rear handle part 40. The securing material 90 may cover at least a portion of the junction 96 between the front handle part 20 and the rear handle part 40. Covering at least a portion of the junction 96 may prevent water, dirt and debris from entering the handle portion 16 through any space between the front handle part 20 and the rear handle part 40. The securing material 90 may be made of any suitable material, including an elastomeric material, for example. The securing material 90 may be less rigid than the front handle part 20 and the rear handle part 40 and may provide a desired grip for the handle portion 16.

In optional embodiments, one or more elements described above may be formed as a single piece. For example, the front handle part 20 and the rear handle part 40 may be formed as a single piece, with a recess 70 defined in the end of the handle portion 16 to slidably receive the graphic insert 80. The securing material 90 may cover the portion of the recess 70 at the end of the handle portion 16, which would involve a minimal amount of securing material 90.

In another embodiment, the securing material 90 and the front handle part 20 or the rear handle part 40 may be formed as a single piece. The single piece may then be snap-fitted or form-fitted with the other of the front handle part 20 and the rear handle part 40. In all of these optional embodiments, at least a portion of the handle portion 16 and/or the graphic insert 80 may transmit light as described above.

### III. Manufacture

Manufacture of a toothbrush according to one embodiment of the present invention may include the steps of (1) molding the front handle part 20, (2) molding the rear handle part 40, (3) positioning the graphic insert 80 between the front handle part 20 and the rear handle part 40 and (4) securing the front handle part 20, the rear handle part 40 and the graphic insert 80. The securing step may include overmolding the securing material 90 onto the front handle part 20 and the rear handle part 40.

In other embodiments of the method of manufacture, one or more of the front handle part 20, rear handle part 40 and securing material 90 may be molded as a single piece. In one of these embodiments, the securing material 90 may be formed with the front handle part 20 or rear handle part 40 with a two-shot injection molding process. The first shot may inject more rigid material to form the front handle part 20 or rear handle part 40, and the second shot may inject more resilient, elastic material to form the securing material 90. The graphic insert 80 may then be positioned in the resulting part and the resulting part may be snap-fitted or form-fitted with the other of the front handle part 20 and rear handle part 40.

If the front handle part 20 and rear handle part 40 are molded as a single piece, the recess 70 may be left open at an end of the handle portion 16. In this method, the graphic insert 80 may be inserted length-wise into the handle portion 16 and the securing material 90 may be molded over at least the open portion of the recess 70.

The molding steps described above may be any molding techniques suitable for the application, including injection molding and compression molding.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Features of various embodiments may be used in combination with features from other embodiments. Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s). Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A toothbrush comprising:
a head portion;
a handle portion including a front handle part, a rear handle part and a graphic insert positioned between the front handle part and the rear handle part, at least a portion of one of the front handle part and the rear handle part being able to transmit light;
wherein at least one of the front handle part and the rear handle part defines a first face and a second face for refracting light entering and exiting the at least one of the front handle part and the rear handle part, the first face oriented at a first angle with respect to the graphic insert, the second face oriented at a second angle with respect to the graphic insert, the first angle being different than the second angle.

2. The toothbrush of claim 1 wherein the first face and the second face are substantially planar.

3. The toothbrush of claim 2 wherein the first face and the second face meet at a curved transition.

4. The toothbrush of claim 2 wherein the first face and the second face meet at an abrupt, angled transition.

5. The toothbrush of claim 1 wherein the graphic insert includes a substantially straight line, whereby the substantially straight line appears substantially non-straight when viewed through the first face and the second face.

6. The toothbrush of claim 1 wherein a securing material covers at least a portion of the front handle part and the rear handle part to secure the front handle part and rear handle part relative to one another.

7. The toothbrush of claim 6 wherein the securing material covers at least a portion of the junction between the front handle part and the rear handle part.

8. The toothbrush of claim 7 wherein at least one of the front handle part and the rear handle part define a recess for receiving the graphic insert.

9. The toothbrush of claim 7 wherein the graphic insert is tightly sandwiched between the front handle part and the rear handle part.

10. The toothbrush of claim 7 wherein at least a portion of the graphic insert is able to transmit light.

11. The toothbrush of claim 10 wherein the front handle part and the rear handle part are both more rigid than the securing material.

12. The toothbrush of claim 11 whereby the securing material prevents water and contaminants from entering the handle portion.

13. A toothbrush comprising:
a head;
a handle extending from the head, at least a portion of the handle being able to transmit light, the handle having a first surface, a second surface and a graphic insert positioned within the handle;
a first light path extending into the handle through the first surface of the handle and extending at least to one side of the graphic insert;
a second light path extending into the handle through the second face of the handle and extending at least to the one side of the graphic insert; and
the first light path exiting the first surface at a first angle relative to the one side of the graphic insert, the second light path exiting the second surface at a second angle relative to the one side of the graphic insert, the first and second angles being different.

14. The toothbrush of claim 13 wherein an appearance of the graphic insert is modified when viewed through the first light path and the second light path simultaneously.

15. The toothbrush of claim 13 wherein at least a portion of the graphic insert transmits light and wherein the first light path and the second light path extend through at least a portion of the graphic insert.

16. The toothbrush of claim 13 wherein the handle includes a front handle part and a rear handle part, the graphic insert positioned between the front handle part and the rear handle part.

17. The toothbrush of claim 16 wherein the handle includes a securing material securing the front handle part and the rear handle part.

18. A method of forming a toothbrush handle comprising:
molding a front handle part;
molding a rear handle part with at least one of the front handle part and the rear handle part having at least two faces oriented at a first angle relative to one another for refracting light,
positioning a graphic insert between the front handle part and the rear handle part; and
securing the front handle part, the rear handle part, and the graphic insert,
whereby the light viewed through the at least two faces exits the at least two faces at a second angle relative to one another.

19. The method of claim 18 wherein the securing step includes placing the front handle part, the rear handle part and the graphic insert into a mold and overmolding an elastomer onto the front handle part and the rear handle part.

20. The method of claim 19 including molding the front handle part and the rear handle part from a more rigid material than the elastomer.
